(19) United States
(12) Patent Application Publication
(10) Pub. No.: US 2002/0176996 A1
(43) Pub. Date: Nov. 28, 2002

(54) Method of electroplating

(76) Inventors: Hsueh-Chung Chen, Taipei Hsien (TW); Teng-Chun Tsai, Hsinchu (TW); Gwo-Shii Yang, Hsinchu (TW); Ming-Sheng Yang, Hsinchu (TW)

Correspondence Address: J.C. PATENTS INC., 4 Venture, Suite 250, Irvine, CA, 92618, US

(21) Appl. No.: 09/863,918

(22) Filed: May 23, 2001

(51) Int. Cl. B32B 9/00; C25D 7/12; C25D 5/48; C25D 3/38

(52) U.S. Cl. 428/425.8; 205/220; 205/291; 205/157

(57) ABSTRACT

The present invention provides a method for electroplating. A substrate is provided with an opening and a metal layer is formed over the substrate and fills the opening. A cleaning solution including benzotriazole is used to clean the surface of the metal layer, while a protective layer is formed on the surface of the metal layer from reactions of benzotriazole with metal.

### BACKGROUND OF THE INVENTION

1. Field of Invention

The present invention relates to a method for manufacturing semiconductor devices. More particularly, the present invention relates to a method of electroplating in semiconductor manufacture processes.

2. Description of Related Art

In conventional manufacture processes of semiconductor devices, electrochemical deposition copper (ECD-Cu) can be used to form copper metal in the dual damascene opening or in the contact opening. De-ionized water is used as a cleaning solution to remove remained chemicals, for example, sulfate, of the electroplating process from the surface of the copper. Next, an annealing step is performed and a metal plug is formed in the contact opening or in the dual damascene opening.

However, de-ionized water can not completely remove the sulfate attached to the surface of the copper. Therefore, the remained sulfate continues to corrode the surface of the copper, further causing damages in the following process.

Furthermore, the annealing step performed after washing with de-ionized water makes the remained sulfate re-crystallize. Later on, after forming a second metal layer on the metal copper, the remained sulfate crystals can cause corrosion at the interface between the metal copper and the second metal layer, thus reducing conductivity between different metal layers.

### SUMMARY OF THE INVENTION

The invention provides a protective layer formed on the surface of the metal layer, protecting the metal layer from oxygen and water during the cleaning process. This protective layer can also protect the surface of the metal layer from corrosion in the following processes.

The present invention provides a method for electroplating. A substrate is provided with an opening. Next, a metal layer is formed over the substrate and fills the opening. A cleaning solution including benzotriazole is used to clean the surface of the metal layer, while a protective layer is formed on the surface of the metal layer from reactions of benzotriazole with metal molecules.

This protective layer, resulting from reactions between the metal layer and the cleaning solution, can protect the surface of the metal layer from damage caused by oxygen and water. Furthermore, the cleaning solution removes the remained sulfate on the surface of the metal layer, so that corrosion will not occur between interfaces of different metal layers in the following processes.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 to FIG. 2 are cross-sectional views illustrating the process steps of electroplating according to one preferred embodiment of this invention.

### DESCRIPTION OF THE PREFERRED EMBODIMENTS

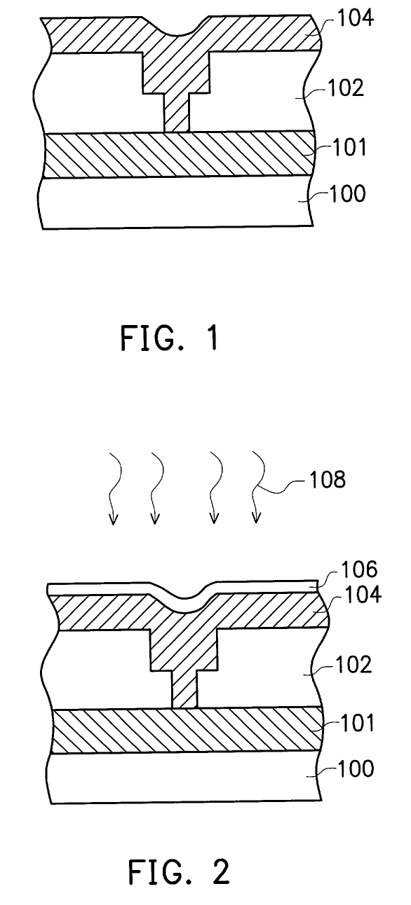

FIG. 1 to FIG. 2 are cross-sectional views illustrating the process steps of electroplating according to one preferred embodiment of this invention.

Referring to FIG. 1, a substrate 100 is provided, containing a first metal layer 101 in the substrate 100. A dielectric layer 102 is formed over the substrate 100 and on the exposed first metal layer 101. The dielectric layer is patterned and an opening is formed in the dielectric layer, thus exposing the first metal layer 101. The opening is, for example, a dual damascene opening. Preferably, a material of the first metal layer 101 comprises copper. Next, a second metal layer 104 is formed over the substrate 100 and fills the opening. Preferably, a material of the second metal layer 104 comprises copper formed by, for example, electrochemical deposition copper (ECD-Cu).

Referring to FIG. 2, a cleaning step 108 is performed to clean the surface of the second metal layer 104 and to remove remained chemicals. The cleaning step 108 comprises using a cleaning solution containing benzotriazole (BTA). A protective layer 106 is formed on the surface of the second metal layer 104 from reactions of the cleaning solution with the second metal layer 104. For example, The protective layer 106 can be formed from final products of reactions between benzotriazole in the cleaning solution and copper, as the second metal layer 104 includes copper. The cleaning solution contains benzotriazole in a weight percentage between 0.01 to 1 percent. The cleaning solution further includes de-ionized water as a solvent. The protective layer 106 is uniformly tight so as to isolate the metal layer from oxygen and water, thus avoiding corrosion on the surface of the metal layer.

Alternately, the cleaning step 108 can be performed in two stages:

Firstly, a first cleaning solution is used to wash off the remained impurities (chemicals) on the surface of the second metal layer 104. The first cleaning solution can be, for example, de-ionized water.

Secondly, a second cleaning solution containing benzotriazole is used. Benzotriazole in the second cleaning solution can react with copper in the second metal layer 104 and the protective layer 106 is formed on the surface of the second metal layer 104.

The present invention is not limited to application for the dual damascene opening, but also application for a contact opening or other types of openings.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for electroplating, comprising:
providing a substrate with an opening;
forming a metal layer over the substrate to fill the opening; and
cleaning a surface of the metal layer with a cleaning solution containing benzotriazole, wherein benzotriazole in the cleaning solution reacts with metal so as to form a protective layer on the surface of the metal layer.

2. The method as claimed in claim 1, wherein the cleaning solution includes deionized water as a solvent.

3. The method as claimed in claim 1, wherein the cleaning solution contains benzotriazole with a weight percentage of about 0.01 to 1 percent.

4. The method as claimed in claim 1, wherein a material of the metal layer comprises copper.

5. The method as claimed in claim 1, wherein the opening is a dual damascene opening.

6. The method as claimed in claim 1, wherein the opening is a contact opening.

7. A protected metal layer formed by electroplating, applied in a substrate with an opening, comprising:
a metal layer formed by electroplating, wherein the metal layer is formed over the substrate and fills the opening;
a protective layer on a surface of the metal layer, wherein the protective layer is formed from reactions of benzotriazole and the metal layer.

8. The metal layer as claimed in claim 7, wherein a material of the metal layer comprises copper.

9. A method of electroplating, comprising:
providing a substrate with an opening;
forming a metal layer over the substrate to fill the opening; and
cleaning a surface of the metal layer with a first cleaning solution; and
cleaning the surface of the metal layer with a second cleaning solution containing benzotriazole, wherein benzotriazole in the second cleaning solution reacts with metal so as to form a protective layer on the surface of the metal layer.

10. The method as claimed in claim 9, wherein the second cleaning solution includes de-ionized water as a solvent.

11. The method as claimed in claim 9, wherein the second cleaning solution contains benzotriazole with a weight percentage of about 0.01 to 1 percent.

12. The method as claimed in claim 9, wherein the first cleaning solution comprises de-ionized water.

13. The method as claimed in claim 9, wherein a material of the metal layer comprises copper.

14. The method as claimed in claim 9, wherein the opening is a dual damascene opening.

15. The method as claimed in claim 9, wherein the opening is a contact opening.
